(19) United States
(12) Patent Application Publication
(10) Pub. No.: US 2026/0119156 A1
(43) Pub. Date: Apr. 30, 2026

(54) METHOD AND SYSTEM FOR A MULTI-MODAL LARGE LANGUAGE MODEL (LLM) GENERATION OF AN UPDATED SOFTWARE ARCHITECTURE

(71) Applicant: JPMorgan Chase Bank, N.A., New York, NY (US)

(72) Inventors: Francis FERNANDES, Claymont, DE (US); Owen DOSSETT, Westfield, IN (US); Wilson HSU, Hockessin, DE (US); Naveen BAJJURI, Pleasanton, CA (US); Ahmed YUSUF, Columbus, OH (US); Chetan D NAVGALE, Thane (IN); Lakshmi DEVI P, Tumakuru (IN)

(73) Assignee: JPMorgan Chase Bank, N.A., New York, NY (US)

(21) Appl. No.: 19/008,115

(22) Filed: Jan. 2, 2025

(30) Foreign Application Priority Data
Oct. 30, 2024 (IN) 202411083209

(51) Int. Cl. G06F 8/65; G06F 16/2458; G06F 40/40

(52) U.S. Cl. CPC G06F 8/65; G06F 16/2458; G06F 40/40

(57) ABSTRACT

A method and system for generating an updated software architecture. The method includes a data scheduler process that periodically obtains an image and a text related to a current software architecture at an architecture artificial intelligence assistant application program interface (ArchAI assistant API) layer, and performing a first drop operation on the image and the text to a storage system. The method also includes initiating a prompt creation process at the ArchAI assistant API layer due to the first drop operation, and generating an enriched prompt for transmission to a multi-modal large language model (LLM). The method also includes performing software architecture configuration analytics by the multi-modal LLM on the current software, generating the updated software architecture by the multi-modal LLM based on a result of the software architecture configuration analytics, and producing a digital diagram of the updated software architecture for display.

### CROSS-REFERENCE TO RELATED APPLICATIONS

This application claims priority benefit from Indian Application No. 202411083209, filed Oct. 30, 2024 in the India Patent Office, which is hereby incorporated by reference in its entirety.

### FIELD OF THE DISCLOSURE

This technology generally relates to methods and systems for a multi-modal large language model (LLM) generation of an updated software architecture.

### BACKGROUND

The proliferation of public cloud services has created a pressing need for companies to update, i.e., optimize, their software architectures (e.g., cloud architectures). Inefficient architectures can result in significant cost overruns and operational challenges. Traditional approaches to software architectural design are often time-consuming, resource-intensive, and prone to errors.

Accordingly, there is a need for techniques of generating an updated software architecture, e.g., by a multi-modal large language model (LLM).

### SUMMARY

The present disclosure, through one or more of its various aspects, embodiments, and/or specific features or sub-components, provides, inter alia, various systems, servers, devices, methods, media, programs, and platforms for generating an updated software architecture.

According to an aspect of the present disclosure, a method of generating an updated software architecture may be provided. The method for generating an updated software architecture, the method being implemented by at least one processor. The method may include implementing a data scheduler process that periodically obtains a plurality of data comprising an image and a text related to a current software architecture at an architecture artificial intelligence assistant application program interface (ArchAI assistant API) layer. The method may also include performing a first drop operation on the image and the text that stores the image and the text in a storage system, and initiating a prompt creation process at the ArchAI assistant API layer due to the first drop operation. The method may also include generating an enriched prompt based on the prompt creation process, wherein the enriched prompt is transmitted to a multi-modal large language model (LLM). The method may also include performing software architecture configuration analytics by the multi-modal LLM on the current software architecture based on the enriched prompt. The method may also include generating the updated software architecture by the multi-modal LLM based on a result of the performing the software architecture configuration analytics, and producing a digital diagram of the updated software architecture for display at a user interface.

The plurality of data may include at least one from cloud data, application data, cost metrics data, software architectural configuration data, infrastructure usage data, enterprise data, and media data as obtained from a plurality of databases that may include at least one enterprise database.

The generating the enriched prompt may include retrieving operational data comprising enterprise documents, test cost metrics, and usage metrics. The generating the enriched prompt may also include performing a retrieval and augmentation (RAG) procedure based on the operational data and the image and the text.

The performing the RAG procedure may include transmitting the operational data, the image, and the text to an embedding model. The performing the RAG procedure may also include generating, by the embedding model, an enhanced query based on the operational data, the image, and the text. The performing the RAG procedure may also transmitting the enhanced query to a vector database.

The performing the software architecture configuration analytics may include analyzing, by the multi-modal LLM, the current software architecture based on the enhanced query to generate the updated software architecture.

The generating the updated software architecture may further include generating rationalized explanations by the multi-modal LLM regarding the updated software architecture.

The producing the digital diagram may include generating the digital diagram of the updated software architecture. The producing the digital diagram may also include performing a second drop operation on the updated software architecture that stores the updated software architecture in the storage system. The producing the digital diagram may also include initiating a push operation process at the ArchAI assistant API layer due to the second drop operation that pushes the digital diagram for display at a user interface.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system.

FIG. 2 illustrates a network diagram of a network environment.

FIG. 3 illustrates a diagram of a system environment according to an embodiment for generating an updated software architecture.

FIG. 4 illustrates a flowchart of an operational process for generating an updated software architecture according to an embodiment.

FIG. 5 illustrates an example process flowchart for generating an updated software architecture according to an embodiment.

FIG. 6 illustrates an example overview of a simplified framework for generating an updated software architecture according to an embodiment.

FIG. 7 illustrates an example response/result comparing an original software architecture with an updated software architecture according to an embodiment.

### DETAILED DESCRIPTION

The proliferation of public cloud services has created a pressing need for companies to optimize their software architectures (e.g., cloud architectures). Inefficient software architectures can result in highly costly overruns and operational challenges. Traditional approaches to software architectural design are often time-consuming, resource-intensive, and prone to errors.

Indeed, organizations are continuously integrating processes into public clouds, with a majority of organizations expected to utilize at least one public cloud. Public cloud providers offer services that remove the need for organization to own all the hardware needed to run compute, memory, or software as a service (SaaS) services on. This allows businesses to focus more on the actual service, rather than the underlying infrastructure behind it. As such, the practice of utilizing public cloud services is quite beneficial to businesses, as exemplified by the presently massive adoption of these public cloud providers.

However, it is noted that the transition to public cloud has led to progressively more complex architectures, due to businesses utilizing hybrid cloud or multiple cloud vendors. These complex software architectures are typically made to reduce costs, but with the added complexity of managing multiple providers with on-premises resources. Thus, the pitfalls into a suboptimized architecture increase.

Additionally, designing and implementing these complex software architectures typically require several highly specialized technicians/engineers to ensure that these SaaS services are designed and delivered correctly. This further amplifies the loss in cost if a suboptimized architecture is deployed.

Moreover, cloud providers introduce new services from time-to-time, which may introduce a new service that an existing application could make use of and reduce cost. However, without continuous checking of the software architecture, this potential saving would go unrealized.

Indeed, the development of robust software architectures may be a complex and resource-intensive process that significantly impacts the overall software development lifecycle. While well-defined software architecture may serve as a critical foundation, its rigidity often hinders agility and innovation. Modifying an established architecture may be time consuming and disruptive, requiring extensive code refactoring and infrastructure adjustments. Consequently, engineering teams may often prioritize feature development over software architectural improvements, leading to suboptimal system performance and increased technical debt.

Furthermore, the absence of automated monitoring mechanisms for cloud applications may result in inefficient resource utilization and unexpected costs. Manual oversight of cloud costs, scalability, and architectural upgrades may be both time-consuming and error-prone, hindering operational efficiency and potentially leading to financial losses.

As such, the pitfalls of poorly optimized cloud architectures may include inefficient use of cloud resources, leading to unexpectedly high bills. Additionally, over-provisioning of resources, idle instances, and not taking advantage of cost-saving features (like reserved instances or spot instances) may all contribute to excessive costs. Suboptimal resource allocation may result in performance bottlenecks. This may include under-provisioning of necessary resources, poor network configurations, and improper storage solutions, leading to sluggish application performance.

Additionally, pitfalls may also include poorly designed architectures that may struggle to scale efficiently when demand increases, leading to service interruptions or degraded performance. Lack of automated scaling policies may exacerbate this issue. Without proper security measures such as regular updates, encrypted data storage, and strict access controls, cloud environments may be susceptible to breaches and unauthorized access. An overly complex architecture may be difficult to manage and maintain. This may often be derived from a lack of standardization, excessive use of microservices, or improper documentation.

Moreover, inadequate redundancy and disaster recovery plans may result in significant downtime during failures. Poorly optimized architectures might not fully leverage availability zones or backup strategies provided by cloud providers. Misconfigured load balancers, lack of content delivery network (CDN) usage, and inefficient routing can lead to higher latency and poor user experiences.

Thus, addressing these pitfalls requires careful planning, regular optimization, and adherence to best practices such as cost management, automated scaling, security hardening, and performance monitoring.

Additional issues hindering improvement in software architecture may include a lack of automated monitoring of cloud applications. Without automated monitoring, it may take longer to detect problems such as server errors, slow response times, or outages. This delay may increase the time to resolution and exacerbate the impact on end-users. Performance degradations may go unnoticed if they are not being actively monitored. This may result in poor user experience, as slow application response times or intermittent failures become more frequent.

Automated monitoring tools may provide alerts and notifications as soon as issues are detected, allowing for faster response times. Without these tools, outages or critical issues might not be addressed promptly, leading to increased downtime. Automated monitoring may help identify unusual activity that might be indicative of a security breach. The absence of such monitoring may leave applications vulnerable to attacks that go unnoticed until considerable damage has occurred. Inefficiencies such as over-provisioned resources, underutilized instances, and unexpected spikes in usage can go unchecked without monitoring. This may lead to unnecessarily high cloud costs that could have been mitigated with proper oversight.

Additionally, many industries (e.g., financial institutions, insurance industries, healthcare industries, etc.) have regulatory requirements that mandate certain levels of monitoring and logging. Failure to implement automated monitoring may result in non-compliance with these regulations, potentially leading to legal repercussions and fines.

Automated monitoring may help manage and scale applications effectively based on usage patterns and performance metrics. Without it, scaling might be reactive rather than proactive, leading to resource constraints and performance bottlenecks during peak times. Regular monitoring may provide valuable data and insights into application performance, usage patterns, and potential areas for improvement. Without automated monitoring, this data may be incomplete or unavailable, hindering strategic decision-making. All the above points contribute to poor user experience. Customers encountering slow, unreliable, or insecure applications may likely be dissatisfied, resulting in churn and damage to the business brand's reputation. Thus, implementing automated monitoring may help mitigate these problems by ensuring that issues may be identified and addressed promptly, thereby maintaining the performance, security, and reliability of cloud applications.

Yet further issues hindering improvement in software architecture may include the costliness of continuous human checking for new software architectures. Assessing existing infrastructure to ensure it meets new standards may often involve detailed and time-consuming analysis. Understanding dependencies, evaluating resource configurations, and identifying gaps may require significant manual effort. Indeed, maintaining and updating detailed documentation of the current architecture and changes may be labor-intensive and critical for future audits and compliance. Moreover, manual processes may be prone to human errors, which may lead to overlooked aspects of the architecture that may not comply with new standards. Rectifying these errors post-implementation may be costly and time-consuming.

In consideration of these new challenges accompanying this wide adoption of public cloud and its tools, there is a need for another type of service that may alleviate these obstacles through routine checking of software architectures with up-to-date information and then providing suggestions to improve the current software architecture.

The present application addresses these challenges and provides a technological improvement of the status quo by enabling a continuously updating and thorough process for software architecture (e.g., but not limited to, cloud architecture) optimization. The present application leverages advanced artificial intelligence (AI) techniques to analyze existing cloud application architectures, identify inefficiencies, and suggest optimizations/improvements to the existing cloud application architectures. The Architectural AI assistant with application program interface (API) layer, dubbed ArchAI assistant API for short, may generate procedural diagrams of updated, i.e., optimized, software architectures and configurations, enabling organizations to reduce costs, accelerate cloud migration, and ensure up-to-date ongoing performance of their cloud-based applications.

The present application addresses these limitations in the status quo by disclosing a generation of an updated, i.e., optimized, software architecture by e.g., a large language model (LLM) such as a multi-modal LLM. It is noted that the terms updated and optimized may be used interchangeably.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

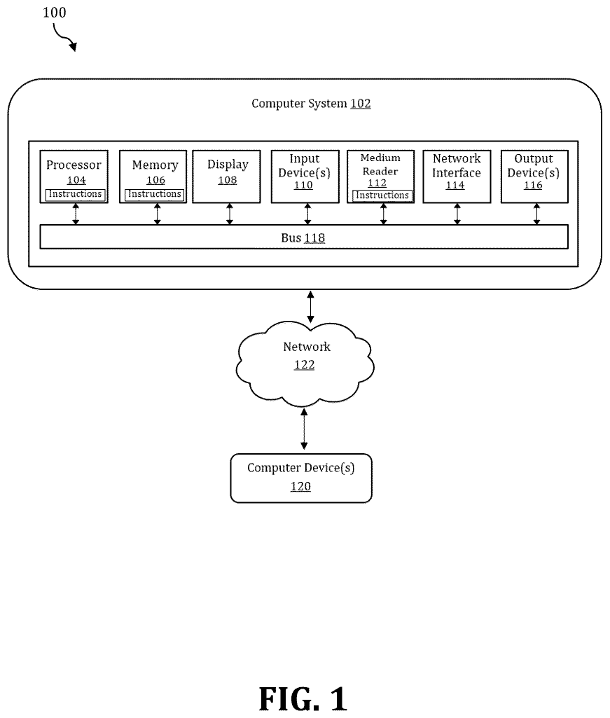

FIG. 1 illustrates a system 100 diagram of a computer system 102 for use in accordance with the embodiments described herein. The system 100 may be generally shown and may include a computer system 102, which may be generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 may be illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, digital optical disk, or any other form of storage medium known in the art. Memories may be volatile or non-volatile, secure and/or encrypted, unsecure and/or unencrypted. Of course, the computer memory 106 may include any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but not limited to, a local area network, a wide area network, the Internet, a telephony network, a short-range network, or any other network commonly known and understood in the art. The short-range network may include, for example, short-range wireless technology standard used for exchanging data between fixed devices and mobile devices over short distances, low-power wireless ad-hoc mesh networks for linking together, infrared, near field communication, ultra-wideband, or any combination thereof. Those skilled in the art appreciate that additional networks 122 which are known and understood may additionally or alternatively be used and that the networks 122 are not limiting or exhaustive. Also, while the network 122 may be illustrated in FIG. 1 as a wireless network, those skilled in the art appreciate that the network 122 may also be a wired network.

The additional computer device 120 may be illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely examples of devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are also similarly not meant to be exhaustive and/or inclusive.

In accordance with various embodiments of the present disclosure, the methods described herein may be implemented using a hardware computer system that executes software programs. Further, in a non-limiting embodiment, implementations may include distributed processing, component/object distributed processing, and parallel processing. Virtual computer system processing may be constructed to implement one or more of the methods or functionalities as described herein, and a processor described herein may be used to support a virtual processing environment.

As described herein, various embodiments provide methods and systems for generation of an updated, i.e., optimized, software architecture by e.g., a multi-modal LLM.

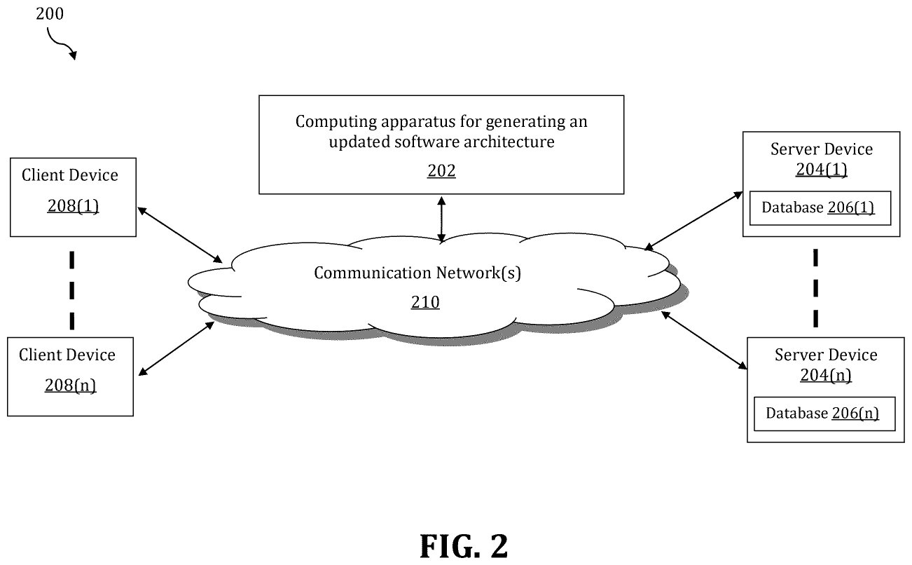

Referring to FIG. 2, a network diagram of a network environment 200 for generation of an updated, i.e., optimized, software architecture by e.g., a multi-modal LLM, may be illustrated. In an embodiment, the method may be executable on any networked computer platform, such as, for example, a personal computer (PC).

The method of a generation of an updated, i.e., optimized, software architecture by e.g., a multi-modal LLM, may be implemented by a computing apparatus 202 that implements the generation of the updated, i.e., optimized, software architecture by e.g., the multi-modal LLM. The computing apparatus 202 may be the same or similar to the computer system 102 as described with respect to FIG. 1. The computing apparatus 202 may store one or more applications that may include executable instructions that, when executed by the computing apparatus 202, cause the computing apparatus 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s) may be located in virtual server(s) running in a cloud-based computing environment rather than being tied to one or more specific physical network computing devices. Also, the application(s) may be running in one or more virtual machines (VMs) executing on the computing apparatus 202. Additionally, in one or more embodiments of this technology, virtual machine(s) running on the computing apparatus 202 may be managed or supervised by a hypervisor.

In the network environment 200 of FIG. 2, the computing apparatus 202 may be coupled to a plurality of server devices 204(1)-204(n) that hosts a plurality of databases 206(1)-206(n), and also to a plurality of client devices 208(1)-208(n) via communication network(s) 210. A communication interface of the computing apparatus 202, such as the network interface 114 of the computer system 102 of FIG. 1, operatively couples and communicates between the computing apparatus 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used. The server devices 204(1)-204(n) and/or the client devices 208(1)-208(n) may provide different computing environments.

The communication network(s) 210 may be the same or similar to the network 122 as described with respect to FIG. 1, although the computing apparatus 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and computing apparatus that efficiently implement a method of generating an updated, i.e., optimized, software architecture by e.g., a multi-modal LLM.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), Public Switched Telephone Network (PSTNs), Ethernet-based Packet Data Networks (PDNs), combinations thereof, and the like.

The computing apparatus 202 may be a standalone device or integrated with one or more other devices or apparatuses, such as one or more of the server devices 204(1)-204(n), for example. In one particular example, the computing apparatus 202 may include or be hosted by one of the server devices 204(1)-204(n), and other arrangements are also possible. Moreover, one or more of the devices of the computing apparatus 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the computing apparatus 202 via the communication network(s) 210 according to the HTTP-based and/or script object notation protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the computing apparatus 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 may be a wireless mobile communication device, i.e., a smart phone.

The client devices 208(1)-208(n) may run interface applications, such as standard web browsers or standalone client applications, which may provide an interface to communicate with the computing apparatus 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the computing apparatus 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are for example purposes, as many variations of the specific hardware and software used to implement the examples are possible, as will be appreciated by those skilled in the relevant art(s).

One or more of the devices depicted in the network environment 200, such as the computing apparatus 202, the server devices 204(1)-204(n), or the client devices 208(1)-208(n), for example, may be configured to operate as a virtual instance on the same physical machine. In other words, one or more of the computing apparatus 202, the server devices 204(1)-204(n), or the client devices 208(1)-208(n) may operate on the same physical device rather than as separate devices communicating through communication network(s) 210. Additionally, there may be more or fewer computing apparatus 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, Packet Data Networks (PDNs), the Internet, intranets, and combinations thereof.

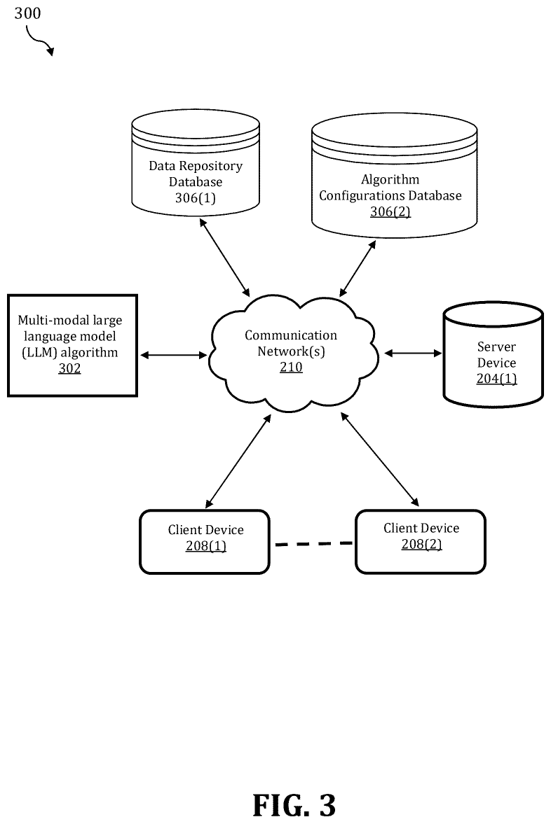

The computing apparatus 202 may be described and illustrated in FIG. 3 as including a multi-modal LLM algorithm 302, although it may include other rules, algorithms, policies, modules, databases, or applications, for example. As will be described below, the multi-modal LLM algorithm 302 may be configured to implement a method for generating an updated software architecture.

FIG. 3 illustrates a diagram of a system environment 300 for implementing a method for generating an updated software architecture of FIG. 2, which may be illustrated as being executed in FIG. 3. Specifically, a first client device 208(1) and a second client device 208(2) are illustrated as being in communication with computing apparatus 202. In this regard, the first client device 208(1) and the second client device 208(2) may be “clients” of the computing apparatus 202 and are described herein as such. Nevertheless, it is to be known and understood that the first client device 208(1) and/or the second client device 208(2) need not necessarily be “clients” of the computing apparatus 202, or any entity described in association therewith herein. Any additional or alternative relationship may exist between either or both of the first client device 208(1) and the second client device 208(2) and the computing apparatus 202, or no relationship may exist.

Further, computing apparatus 202 may be illustrated as being able to access a data repository database 306(1) and an algorithm configurations database 306(2). The multi-modal LLM algorithm 302 may be configured to access these databases for implementing the generation of an updated software architecture.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the computing apparatus 202 via broadband or cellular communication. Of course, these embodiments are merely examples and are not limiting or exhaustive.

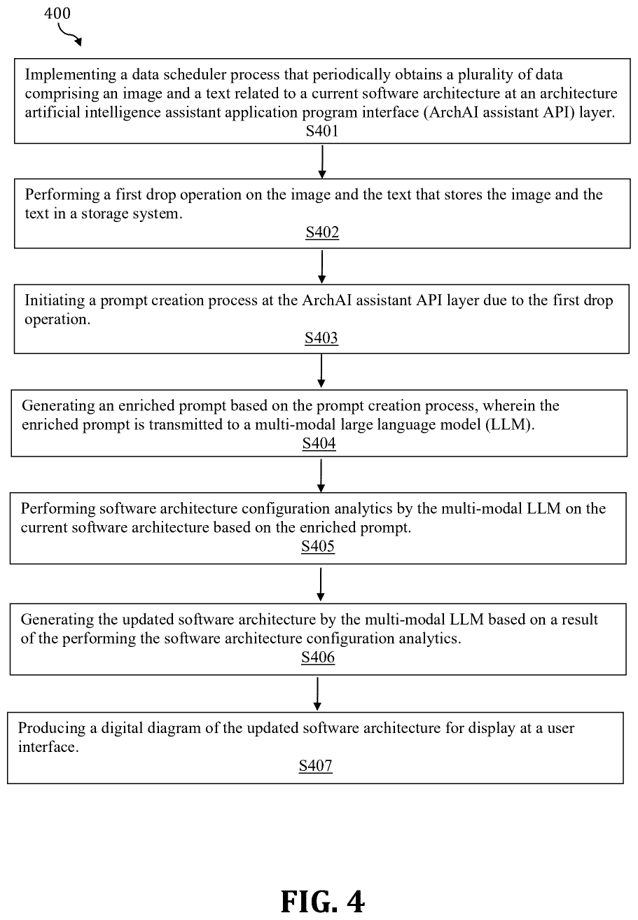

Upon being started, the multi-modal LLM algorithm 302 executes a process implementing a method for generating an updated software architecture. A process for generating an updated software architecture by e.g., a multi-modal LLM, may be generally indicated at flowchart 400 in FIG. 4.

FIG. 4 illustrates a flowchart of a process diagram 400 of a process for generating an updated software architecture according to an embodiment. The process diagram 400 may be implemented by the system environment 300 of FIG. 3, a network environment 200 of FIG. 2, and the system 100 of FIG. 1.

At step S401 of the flowchart process 400, the computing apparatus 202 may implement a data scheduler process that periodically obtains a plurality of data comprising an image and a text related to a current software architecture at an architecture artificial intelligence assistant application program interface (ArchAI assistant API) layer. The plurality of data may include at least one from cloud data, application data, cost metrics data, software architectural configuration data, infrastructure usage data, enterprise data, and media data as obtained from a plurality of databases may include at least one enterprise database.

At step S402, the computing apparatus 202 may perform a first drop operation on the image and the text that stores the image and the text in a storage system.

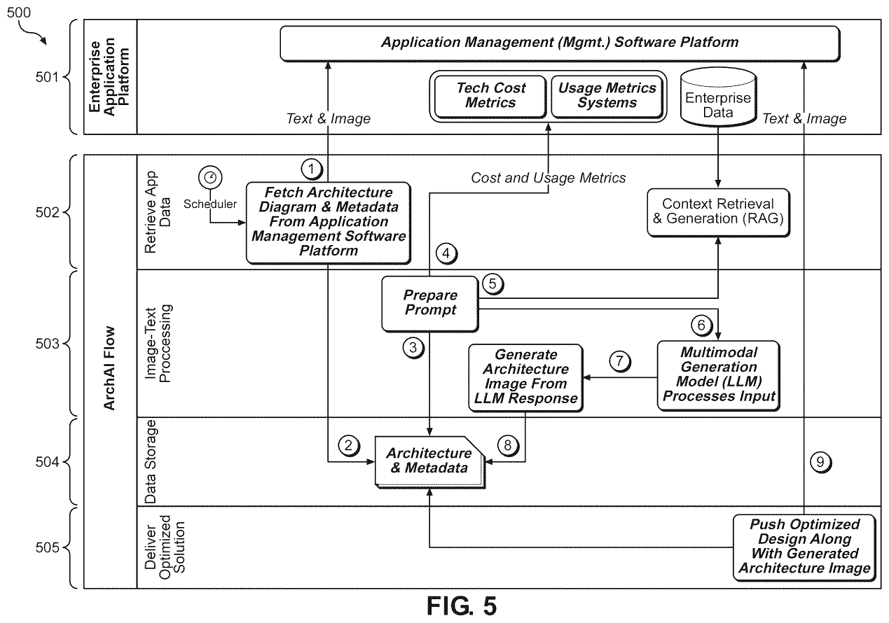

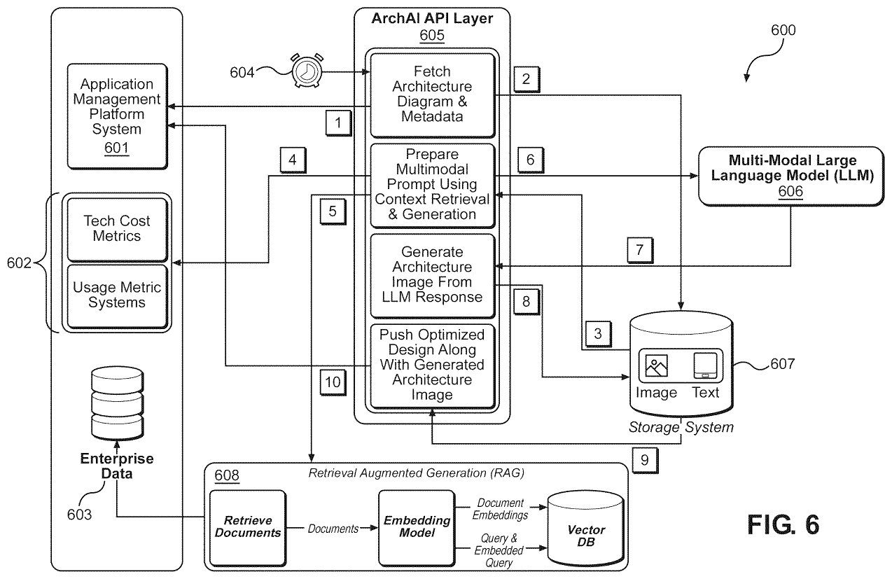

At step S403, the computing apparatus 202 may initiate a prompt creation process at the ArchAI assistant API layer due to the first drop operation. Further details of the prompt creation process are described in FIGS. 5 and 6.

At step S404, the computing apparatus 202 may generate an enriched prompt based on the prompt creation process, wherein the enriched prompt is transmitted to a multi-modal large language model (LLM). The generation of the enriched prompt may include retrieving operational data comprising enterprise documents, test cost metrics, and usage metrics. The generation of the enriched prompt may also include performing a retrieval and augmentation (RAG) procedure based on the operational data and the image and the text.

Continuing with step S404, the performing the RAG procedure may include transmitting the operational data, the image, and the text to an embedding model. The embedding model may be a multi-modal embedding model. The RAG procedure may also include generating, by the embedding model, an enhanced query based on the operational data, the image, and the text. The RAG procedure may also include transmitting the enhanced query to a vector database. Further details of the RAG procedure are described in FIGS. 5 and 6.

At step S405, the computing apparatus 202 may perform software architecture configuration analytics by the multi-modal LLM on the current software architecture based on the enriched prompt. The perform the software architecture configuration analytics may include analyzing, by the multi-modal LLM, the current software architecture based on the enhanced query to generate the updated software architecture. Further details of the multi-modal LLM and the software architecture configuration analytics are described in FIGS. 5 and 6.

At step S406, the computing apparatus 202 may generate the updated software architecture by the multi-modal LLM based on a result of the performing the software architecture configuration analytics. The generating the updated software architecture may include generating rationalized explanations by the multi-modal LLM regarding the updated software architecture. The rationalized explanations may include e.g., explanations for why the updated software architecture with a particular architecture configuration was generated, why the updated software architecture is an improvement/optimization over the current software architecture, etc.

At step S407, the computing apparatus 202 may produce a digital diagram of the updated software architecture for display at a user interface. The producing the digital diagram may include generating the digital diagram of the updated software architecture. The producing the digital diagram may further include performing a second drop operation on the updated software architecture that stores the updated software architecture in the storage system. The producing the digital diagram may further include initiating a push operation process at the ArchAI assistant API layer due to the second drop operation that pushes the digital diagram for display at a user interface.

FIG. 5 illustrates an example process flowchart 500 for generating an updated software architecture according to an embodiment as described in FIG. 4.

The example process flowchart 500 includes an enterprise application platform 501 with application management software platform. At step 1 involving the enterprise application platform 501, a scheduled process retrieves architecture diagrams and relevant application metadata from the application management software platform. Additionally, the application management software platform may also include tech cost metrics and usage metrics system for obtaining tech cost metrics and usage metrics data.

The example process flowchart 500 may also include the ArchAI assist/assistant flow, which may include a retrieve application data 502, image-text processing 503, data storage 504, and deliver optimized solution 505. The retrieve application data 502 may include a scheduler and a serverless function service that may include a fetch architecture diagram and metadata that may be obtained from the application management software platform (see step 1). Once obtained, the application image and metadata may be transmitted for data storage 504 on a scalable data storage system such as, but not limited to, a cloud object storage system that may be used to store existing software architecture and recommended updated, i.e., optimized software architecture (step 2).

The image-text processing 503 may include a serverless function service with an additional service that may include preparing multi-modal input prompt by obtaining images and metadata from the scalable data storage system (step 3) and obtaining cost and usages from the enterprise application platform 501 (step 4), which may be used as part of the prompt generation process. The additional service may also obtain software architecture data (e.g., existing or recommended software architecture data) from data storage 504 that may also be used as part of the prompt generation process. That is, the data storage system may put event, such as software architecture data, to the image-text processing 503.

Continuing with the image-text processing 503, at step 5, the prompt may be enriched with contextual retrieval and generation (RAG). Using the prompt, a Generative AI development operations (GenAI DevOps) platform may be called with the prompt to onboard a multi-modal large language model (LLM). The GenAI DevOps platform may be a large language model (LLM) platform that may operate on a cloud.

At step 6, the multi-modal LLM may be queried using the enriched prompt. That is, the multi-modal LLM processes the input. At step 7, the multi-modal LLM may analyze and understand the existing software architecture and generate a response for a new optimized software architecture. Based on the multi-modal LLM response, an image generator may create a digital image of the optimized software architecture using details from the multi-modal LLM response (step 8).

The result may be text explanations and a diagram of an optimized software architecture, i.e., electronic text explanations and digital diagram. For instance, a digital diagram of the optimized software architecture image may be generated from the multi-modal LLM response. That is, the result of the multi-modal LLM response may include a digital diagram of the optimized software architecture and design details, and electronic text explanations that provides rationalized explanations regarding the optimized software architecture (step 8). Examples of such rationalized explanations may be, but are not limited to, why the optimized software architecture and its particular software architecture are recommended, what improvements the optimized software architecture provides over the existing software architecture, etc.

As stated above, the multi-modal LLM and the process may also include an embedding model, wherein the embedding model may also be a multi-modal embedding model. The result of the generated responses by the multi-modal LLM, e.g., the explanations and the diagram of an optimized software architecture, may be stored at the data storage 504. The generated responses by the multi-modal LLM may be stored for data storage 504 in data storage systems or data storage mediums for easy access from later workflow steps and for internal developers/programmers/engineers to have a centralized repository to view inputs and outputs. These outputs may be tagged with the application with which they are associated to allow for easy tracking of application software architecture optimizations.

The deliver optimized solution 505 section of the ArchAI assist/assistant flow may push the optimized software architecture image and design to the application management software platform (step 9).

FIG. 6 illustrates an example overview of a simplified framework for generating an updated software architecture according to an embodiment as described in FIG. 4. The simplified framework 600 may include an application management platform system 601, a tech cost metrics and a usage metrics system 602, an enterprise data database 603, a scheduler 604, an ArchAI application program interface (API) layer 605, a multi-modal LLM 606, a storage system 607, and a retrieval augmented generation (RAG) 608 section.

At step 1, the scheduler 604 may schedule a process. The process may occur at the ArchAI API layer 605 and runs periodically to fetch software architecture diagrams and related application information from the application management platform system 601. At step 2, the ArchAI API layer 605 may perform a drop operation to drop image and text data into the storage system 607.

The drop at step 2 may then trigger a prompt creation process (step 3). The prompt creation process may include a preparation of the multi-modal/multimodal prompt using a context retrieval and generation (RAG) process at the ArchAI API layer 605. The process may involve fetching tech cost metrics and usage metrics (step 4) from the tech cost metrics and usage metrics system 602.

At step 5, the prompt may be enriched with context from the RAG 608 section. The RAG 608 section may include retrieving documents from and providing data to the enterprise data database 603. The retrieved documents may be transmitted to an embedding model, which may also be a multi-modal embedding model. The embedding model may then generate a query with an image and a text prompt, an embedded query, and various document embeddings, which may then be transmitted to the vector database (DB).

The vector DB may then incorporate a context to the query with the image and text prompt, embedding query, and various document embeddings for input into the multi-modal LLM 606. That is, the vector DB provides and an enhanced context to the various components inputted into it. The vector DB may be a high-dimensional vector.

Once the multi-modal prompt has been prepared, the prepared prompt may then be used to query the multi-modal LLM 606 (step 6). The multi-modal LLM 606 may analyze and understand the existing software architecture and generate a response (step 7) with an updated/optimized software architecture and corresponding explanations. Based on the multi-modal LLM response, an image generator may generate a digital image using details from the response of the multi-modal LLM 606 (step 8). The digital image and optimized software architecture design solution may be dropped into the storage system 607 (step 8).

The drop in the storage system 607 at step 8 may trigger an event to push the optimized software architecture design along with the generated software architecture image (i.e., the digital image) and the explanations (step 9). Notably, the optimized software architecture design and the explanations and suggestions related to the optimized software architecture design may be pushed from the ArchAI API layer 605 to the application management platform system 601.

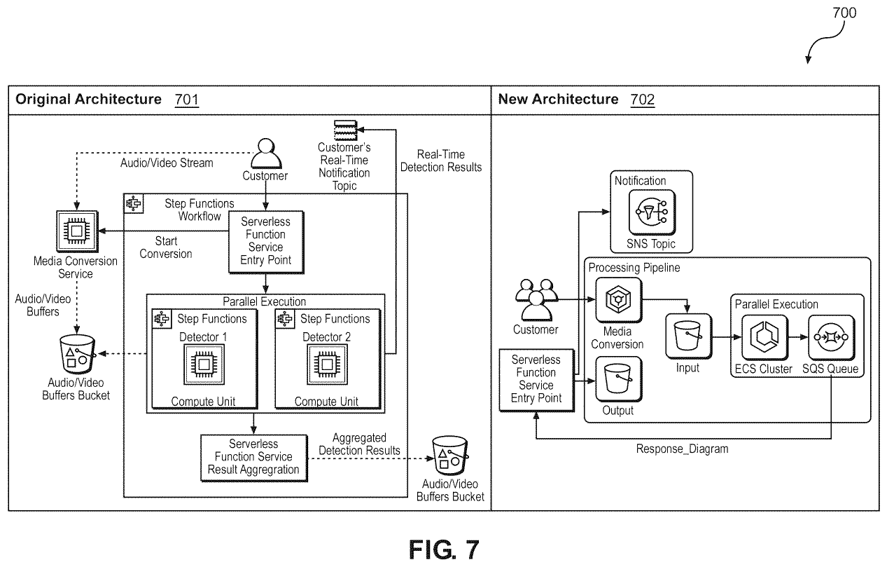

FIG. 7 illustrates an example response/result comparing an original software architecture with an updated software architecture 700 according to an embodiment as described in FIG. 4. The original software architecture process 701 may include providing an original software architecture by a user/customer into a serverless function service entry point, which may perform a conversion of the original software architecture. That is, the original software architecture may include audio/video stream data that may need to be converted via a media conversion service, wherein the converted media would be sent via audio/video buffers to an audio/video buffers bucket. The data from the original software architecture that does not need conversion may be sent for parallel execution to detectors 1 and 2 to perform parallel step functions. The results of such step functions may be sent to the audio/video buffers bucket, as well as a service function service result aggregation to aggregate the detection results from detectors 1 and 2 for the audio/video buffers bucket. Additionally, the results may also be sent to the user/customer via real-time notifications topic to provide the notifications.

In contrast to the tediousness and resource consuming process of the original software architecture, the new software architecture 702 may be more condensed and streamlined. That is, the new software architecture 702 denotes an optimized software architecture. For instance, data from the user/customer may be sent to for media conversion to generate an input for the parallel execution by an elastic container service (ECS) cluster and a simple queue service (SQS) queue. The ECS cluster and SQS queue may then generate a resulting response diagram for the serverless function service entry point. The serverless function service entry point may then provide this resulting response diagram to a simple notification service (SNS) topic to provide the notifications to the user/customer.

Continuing with FIG. 7, explanations may also be provided with reasons for the new software architecture 702 and why it may represent an optimization/improvement over the original software architecture. For instance, the new software architecture 702 may replace the parallel step functions with the ECS because the use case mentioned associated with the original software architecture mentioned reaching accounts limits with step functions due to multiple state transitions per second. As such, the switch to ECS may be recommended because ECS may provide better scalability and cost-effectiveness for high-volume and concurrent processing operations.

A second reason for the new software architecture 702 may be the introduction of SQS for queueing. The reason for utilizing SQS may be to decouple the processing stages and manage the high volume of messages between components. This may help in handling back-pressure and ensure smoother operations between peak loads of data processing.

A third reason for the new software architecture 702 may be consolidating multiple operational functions into a single ECS cluster in order to reduce the individual number of operational function invocations and associated costs. ECS may handle long-running processes more efficiently and thus, may be more cost-effective when handling consistent data workloads.

A fourth reason for the new software architecture 702 may be removing individual detector microservices (e.g., detectors 1 and 2 in the original software architecture). Thus, instead of having separate microservices for each detector, the ECS cluster may host multiple containers for different detection tasks. Thus, improving resource utilization and reducing operational complexity.

A fifth reason for the new software architecture 702 may be simplifying the workflow by removing nested step functions. The original software architecture had multiple levels of step functions, which may contribute to a scaling bottleneck. As such, the new software architecture 702 flattens the original software architecture to enable better performance and cost-efficiency.

A sixth reason for the new software architecture 702 may be retaining of a single operational function to perform the result aggregation. This may maintain a lightweight component for aggregating results from the ECS cluster before storage and notification to the user/customer.

These various reasons may be provided to the user along with the new software architecture 702 so that the user/customer would be understand the motivation and reasons for the new software architecture 702. That is, the various reasons may denote explanations regarding the new software architecture 702 and its improvement/optimization over the original software architecture.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure may be considered to include any computer-readable medium or other equivalents and successor media, in which data or instructions may be stored.

Although the present application describes specific embodiments which may be implemented as computer programs or code segments in computer-readable media, it may be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

Although the present specification describes various numeric values, it is noted that these values are example values and are not intended to limit or restrict the present application to those values. Accordingly, replacement values having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method of generating an updated software architecture, the method being implemented by at least one processor, the method comprising:
implementing a data scheduler process that periodically obtains a plurality of data comprising an image and a text related to a current software architecture at an architecture artificial intelligence assistant application program interface (ArchAI assistant API) layer;
performing a first drop operation on the image and the text that stores the image and the text in a storage system;
initiating a prompt creation process at the ArchAI assistant API layer due to the first drop operation;
generating an enriched prompt based on the prompt creation process, wherein the enriched prompt is transmitted to a multi-modal large language model (LLM);
performing software architecture configuration analytics by the multi-modal LLM on the current software architecture based on the enriched prompt;
generating the updated software architecture by the multi-modal LLM based on a result of the performing the software architecture configuration analytics; and
producing a digital diagram of the updated software architecture for display at a user interface.

2. The method of claim 1, wherein the plurality of data comprises at least one from cloud data, application data, cost metrics data, software architectural configuration data, infrastructure usage data, enterprise data, and media data as obtained from a plurality of databases comprising at least one enterprise database.

3. The method of claim 1, wherein the generating the enriched prompt comprises:
retrieving operational data comprising enterprise documents, test cost metrics, and usage metrics; and
performing a retrieval and augmentation (RAG) procedure based on the operational data and the image and the text.

4. The method of claim 3, wherein the performing the RAG procedure comprises:
transmitting the operational data, the image, and the text to an embedding model;
generating, by the embedding model, an enhanced query based on the operational data, the image, and the text; and
transmitting the enhanced query to a vector database.

5. The method of claim 4, wherein the performing the software architecture configuration analytics comprises:
analyzing, by the multi-modal LLM, the current software architecture based on the enhanced query to generate the updated software architecture.

6. The method of claim 5, wherein the generating the updated software architecture further comprises generating rationalized explanations by the multi-modal LLM regarding the updated software architecture.

7. The method of claim 6, wherein the producing the digital diagram comprises:
generating the digital diagram of the updated software architecture;
performing a second drop operation on the updated software architecture that stores the updated software architecture in the storage system; and
initiating a push operation process at the ArchAI assistant API layer due to the second drop operation that pushes the digital diagram for display at a user interface.
